(19) United States
(12) Patent Application Publication
(10) Pub. No.: US 2011/0206211 A1
(43) Pub. Date: Aug. 25, 2011

(54) AUDIO MANAGEMENT SYSTEM

(75) Inventors: Naftali Dahan, Raanana (IL); Daniel Atia, Netanya (IL); Tova Inbal, Kfar Saba (IL); Daniel Avraham, Kfar Yona (IL); Tzahi Bachar, Yokneam (IL)

(73) Assignee: Orbit Communication System Ltd., Netanya (IL)

(21) Appl. No.: 12/871,968

(22) Filed: Aug. 31, 2010

Related U.S. Application Data
(60) Provisional application No. 61/306,502, filed on Feb. 21, 2010.

(51) Int. Cl. H04R 29/00; H04B 1/00; H04B 15/00

(52) U.S. Cl. 381/58; 381/123; 381/86; 381/94.1

(57) ABSTRACT

A system and method for combining multiple media types for demanding mobile communications environments, such as airborne and ship borne communications. The system facilitates integration of multiple media types into a common system, enabling use of the optimal communication system for each media type when possible, and transfer of media between communication systems as necessary. The system facilitates convergence of various media types to a common communications system, for example transferring voice and data over a common IP communications system, integrated control and management of the communications systems including interconnection configuration, priority, and accessibility with integrated management of shared resources. The system is designed to meet all Federal Aviation Administration (FAA) regulatory requirements.

### FIELD OF THE INVENTION

The present embodiment generally relates to communications, and in particular, it concerns a system and method for combining multiple media types for airborne and ship borne communications.

### BACKGROUND OF THE INVENTION

Conventional airborne and ship borne communications include multiple communication systems. Each communication system handles a separate media type, with functionality limited to that media type, and each communication system requiring individual operation and maintenance. In this context, a media type is a type of information to be communicated, including, but not limited to voice, video, and data, and a communication system is a system designed to transfer one or more media types. External coordination must be done between each communication system. In addition, conventional systems do not take advantage of currently available technologies such as voice over IP (VOIP), and the accompanying known advantages of VOIP. Conventional systems can transfer voice, video, and data using individual systems, each system limited in bandwidth due to both hardware and regulatory constraints.

There is therefore a need for an integrated system for airborne and ship borne communications, optimizing the use of individual communications systems while providing integrated control, transfer of data between systems, and sharing of commonly needed resources.

### SUMMARY

A system and method for combining multiple media types for demanding mobile communications environments, such as airborne and ship borne communications. The system facilitates integration of multiple media types into a common system, enabling use of the optimal communication system for each media type when possible, and transfer of media between communication systems as necessary. The system facilitates convergence of various media types to a common communications system, for example transferring voice and data over a common IP communications system, integrated control and management of the communications systems including interconnection configuration, priority, and accessibility with integrated management of shared resources. The system is designed to meet all Federal Aviation Administration (FAA) regulatory requirements.

To facilitate integration of audio communications into a common system, a digital signal processing (DSP)-based switching system is used to convert audio channels between a variety of audio formats and switch audio channels between communication systems as necessary.

An innovative technique uses an architecture including fixed attenuation of signals at entry to prevent crosstalk. Specifically, given a known signal input range and a known receive signal input range, a fixed attenuation can be calculated and used near where a signal is input, preventing high current at the input circuit, reducing capacitance and inductance effects signal transmitted by the printed circuit board conductors, resulting in prevention of crosstalk between channels. A feature of this technique is that a wide dynamic range of input signals can be received.

An innovative system for radio channel calibration is also described.

According to the teachings of the present embodiment there is provided, a system for switching signals including: a plurality of digital audio sources (Sk) each providing an audio channel with associated source amplitude (Ik); a plurality of audio destinations (Dm); a digital signal processor (DSP) operationally connected to each of the plurality of digital audio sources (Sk) and operationally connected to each of the plurality of audio destinations (Dm), the DSP configured to: associate the plurality of audio destinations (Dm) with the plurality of digital audio sources (Sk); generate an amplified input (Amklk) for each of the plurality of digital audio sources (Sk) that has an association with one or more of the plurality of audio destinations (Dm) by multiplying each of the associated source amplitudes (Ik) by an input gain (Amk), the input gain (Amk) based on one of the plurality of digital audio sources (Sk) and an associated one of the plurality of audio destinations (Dm); and generate combined amplified inputs (Sum[AmkIk]) for each of the plurality of audio destinations (Dm) by combining the amplified input (AmkIk) for each of the plurality of digital audio sources (Sk) that is respectively associated with each of the plurality of audio destinations (Dm); and output the combined amplified inputs (Sum[AmkIk]) as destination amplitudes (Om) to correspondingly each of the plurality of audio destinations (Dm).

In an optional embodiment, the system is further configured to generate destination amplitudes (Om) by multiplying each of the combined amplified inputs (Sum[AmkIk]) by an output gain (Mm), the output gain (Mm) based on an associated one of the audio destinations (Dm);

In another optional embodiment, the input gain (Amk) is set to zero for each of the plurality of digital audio sources (Sk) that lacks an associated one of the plurality of audio destinations (Dm). In another optional embodiment, the DSP is configured to accept at least one of the plurality of digital audio sources (Sk) having an effective analog bandwidth equivalent of 6 KHz. In another optional embodiment, the DSP is configured to accept at least one of the plurality of digital audio sources (Sk) having a sampling rate of 16 KHz and 16 bits of data. In another optional embodiment, the plurality of digital audio sources includes airborne audio control panels (ACPs).

According to the teachings of the present embodiment there is provided, a method for crosstalk reduction including the steps of: receiving a first analog input signal (502) having a first signal input range (506), at a first signal input terminal (500); receiving a second analog input signal (512) having a second signal input range (516), at a second signal input terminal (510); and applying a first attenuation to the first analog input signal (502) wherein the first attenuation is based on the first signal input range (506) such that a first crosstalk signal generated by a first receive circuit (521) operationally connected to the first signal input terminal (500) and received by a second receive circuit (531) operationally connected to the second signal input terminal (510), is less than a pre-determined crosstalk maximum.

In an optional embodiment, the first signal input range (506) is between a pre-determined first minimum amplitude (508A) of 200 mV and a pre-determined first maximum amplitude (508B) of 12 V. In another optional embodiment, the first attenuation is 23 dB. In another optional embodiment, the a distance from the first signal input terminal (500) to a first fixed attenuation network (541) is less than a calculated distance, the calculated distance based on a bandwidth of the first analog input signal (502), such that a calculated crosstalk signal generated by the first analog input signal (502) is less than the pre-determined crosstalk maximum. In another optional embodiment, a bandwidth of the first analog input signal (502) is 10 KHz or less and a distance from the first signal input terminal (500) to a first fixed attenuation network (541) is 3 inches or less.

In an optional embodiment, the method further includes the step of applying a second attenuation to the second analog input signal (512) wherein the second attenuation is based on the second signal input range (516) such that a second crosstalk signal generated by a second receive circuit (531) operationally connected to the second signal input terminal (510) and received by a first receive circuit (521) operationally connected to the first signal input terminal (500), is less than a pre-determined crosstalk maximum. In another optional embodiment, the first signal input range (506) is substantially equal to the second signal input range (516), the first receive signal input range (526) is substantially equal to the second receive signal input range (536), and hence the first attenuation is substantially equal to the second attenuation.

According to the teachings of the present embodiment there is provided, a system for calibration including: a test signal generator (602) configured for generating one or more test signals; an VOIP audio interface unit (VAIU) (600) operationally connected to the test signal generator (602), the VAIU configured to transmit one or more output signals, each of the one or more output signals (604) deriving from a corresponding one of the one or more test signals; one or more signal analyzers (606) operationally connected to the VAIU (600), the one or more signal analyzers (606) configured to receive the one or more output signals (604) and generate one or more signal parameters corresponding to each of the one or more output signals (604); and a controller (608) operationally connected to the VAIU (600) and operationally connected to the one or more signal analyzers (606), the controller configured to: process the one or more signal parameters with corresponding one of the one or more test signals to generate corresponding one or more compensation factors; and facilitate storage of the one or more compensation factors in association with the corresponding one of the one or more test signals.

In an optional embodiment, the test signal generator is included in the VAIU. In another optional embodiment, the test signal generator is a digital signal processor (DSP)-based fixed tone generator. In another optional embodiment, the test signal generator is configured to generate audio test signals. In another optional embodiment, the VAIU is included in an aircraft communications system. In another optional embodiment, the test signal generator is configured for generating the one or more test signals with respective amplitudes between 0.1 volts (V) and 1.5 V in steps of 0.1 V.

In an optional embodiment, the test signal generator is configured for generating the one or more test signals with amplitudes based on comparing the one or more signal parameters to a pre-determined required amplitude. In another optional embodiment, the test signal generator is configured to repeat generating the one or more test signals with amplitudes based on comparing the one or more signal parameters to a pre-determined required amplitude until the one or more signal parameters are within a pre-determined error range of the pre-determined required amplitude.

In another optional embodiment, the controller is included in the VAIU. In another optional embodiment, the one or more compensation factors are stored in the VAIU. In another optional embodiment, the one or more aircraft radios (610) operationally connected to the VAIU, each of the one or more aircraft radios having a pre-determined radio input amplitude, and wherein the VAIU is configured to use the one or more compensation factors to transmit one or more communication signals at the pre-determined radio input amplitude to a respective one or more radios.

### BRIEF DESCRIPTION OF FIGURES

The embodiment is herein described, by way of example only, with reference to the accompanying drawings, wherein:

FIG. 1 is high-level diagram of the architecture of a system for combining multiple media types for airborne and ship borne communications.

FIG. 2 is a high-level diagram of connections between the AMSIP and external communications systems.

FIG. 3, a detailed interconnection diagram of the architecture of a system for combining multiple media types for airborne and ship borne communications.

FIG. 4, a diagram of a DSP-based audio switching system.

FIG. 5A, a diagram of a system for crosstalk prevention.

FIG. 5B is a detailed diagram of one exemplary implementation of a crosstalk prevention system.

FIG. 6A, a general diagram of a system for radio channel calibration.

FIG. 6B, a flowchart of an exemplary method for radio channel calibration.

FIG. 7, a diagram of emergency mode operation.

FIG. 8 is an example of a SIP call setup procedure.

FIG. 9 is a diagram of ACP and radio redundancy.

FIG. 10 is a diagram of backup mode.

FIG. 11 is a diagram of an example of some of the internal aircraft and external communications connections.

### DETAILED DESCRIPTION

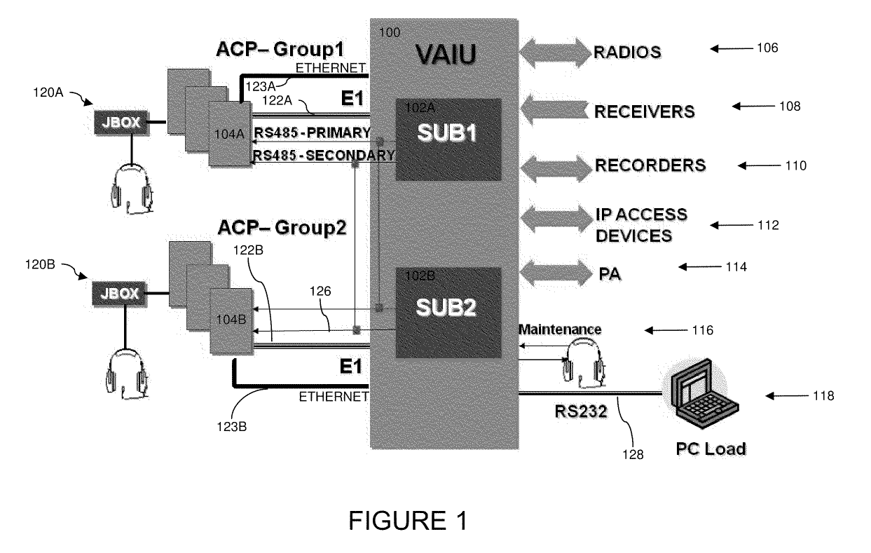

### Architecture—FIGS. 1, 2, 3

The principles and operation of the system according to the present embodiment may be better understood with reference to the drawings and the accompanying description. The present embodiment is a system and method for combining multiple media types for airborne and ship borne communications. The system facilitates integration of multiple media types into a common system, enabling use of the optimal communication system for each media type when possible, and transfer (commonly known as conversion or gateway) of media between communication systems as necessary. The system facilitates convergence of various media types to a common communications system, for example transferring voice and data over a common IP (internet protocol) communications system. The system further facilitates integrated control and management of the communications systems including interconnection configuration, priority, and accessibility with integrated management of shared resources, for example communications system bandwidth and airborne external communications systems such as radios. The system is designed to meet all Federal Aviation Administration (FAA) regulatory requirements.

Note that this system and method can be implemented for either fixed or mobile applications in a variety of environments. The innovative advantages of this system and method are better seen in demanding mobile communications environments, hence the description below uses implementations of an airborne communications system to clarify the present embodiment.

Referring now to the drawings, FIG. 1 is high-level diagram of the architecture of a system for combining multiple media types for airborne and ship borne communications, known as Audio Management System over IP (AMSIP). A centralized audio management unit (AMU) is implemented as a VOIP audio interface unit (VAIU) 100, including at least two sub-VAIUs—sub-VAIU1 102A, and sub-VAIU2 102B to facilitate redundancy. In this description both the general term AMU and specific implementation VAIU are used depending on the context. Aircraft communication systems are connected to the VAIU 100. As will be described below, aircraft communication systems are connected redundantly to sub-VAIU1 102A, and sub-VAIU2 102B. The specific redundant configurations depend on the communication system and desired level of redundancy.

System components include, but are not limited to:

104A, 104B—ACP groups 1 and 2

106—Radios. The VAIU supports connection and operation of multiple radios, while providing receive (RX) and transmit (TX) audio lines and push-to-talk (PTT) lines for interfacing with each radio in the aircraft.

108—Receivers. The VAIU supports connection to multiple receivers, including navigation, playback, warning signals, and other audio receive signals, while providing RX audio lines for interfacing with each receiver in the aircraft

110—Recorders. The VAIU supports connection to multiple recorders. Recorders can be used to record a variety of signals, including, but not limited to the headphone signal 1 of a desired operator, analog, E1, and Ethernet. Recorders also provide TX audio lines for interfacing with other components in an aircraft.

112—IP access devices. The VAIU supports connection to multiple IP interface devices, such as IP phones, IP radios, IP recorders, system parameters loading computer, and other devices with IP interfaces.

114—Public address (PA) system. The VAIU supports connection and operation of a public address system, while providing RX and TX audio lines, chime enable discrete line, and PTT lines for interfacing with the PA system.

116—Maintenance. The VAIU supports connection and operation for a ground maintenance crew, to enable communication with ground crew technicians, while an aircraft is on the ground, while providing microphone input and headphone output interface for the maintenance crew headset connection.

118—PC for loading configurations. The VAIU supports connection to multiple IP interface devices, as detailed above, including the system parameters loading computer, which is used to set the different system levels and parameters. The PC can be connected to a VAIU via industry standard communications, including but not limited to, RS-232 128 and Ethernet.

120A, 120B—JBOX. Jboxes, as commonly known in the field, are units used for providing connections for operator communications accessories, such as microphones, headphones, headsets, and providing connectors for connection to an ACP.

122A, 122B—E1-Standard digital audio interface (2.048 Mbps), containing 31 slots. This line is used for sending commands between an ACP and VAIU, such as functions selection, volume setting and other, as well as driving the digital audio signal from ACP to VAIU (for transmission) and from VAIU to ACP (driving the receive selected signals to headphones).

123A, 123B—Ethernet connectivity between ACPs and the VAIU used for sending commands between an ACP and VAIU, such as functions selection, volume setting and other, as well as driving the digital audio signal from ACP to VAIU (for transmission) and from VAIU to ACP (driving the receive selected signals to headphones).

124—RS-485 primary. Standard control bus, used for communicating when the system is in emergency and backup modes.

126—RS-485 secondary. Redundant RS-485 control bus.

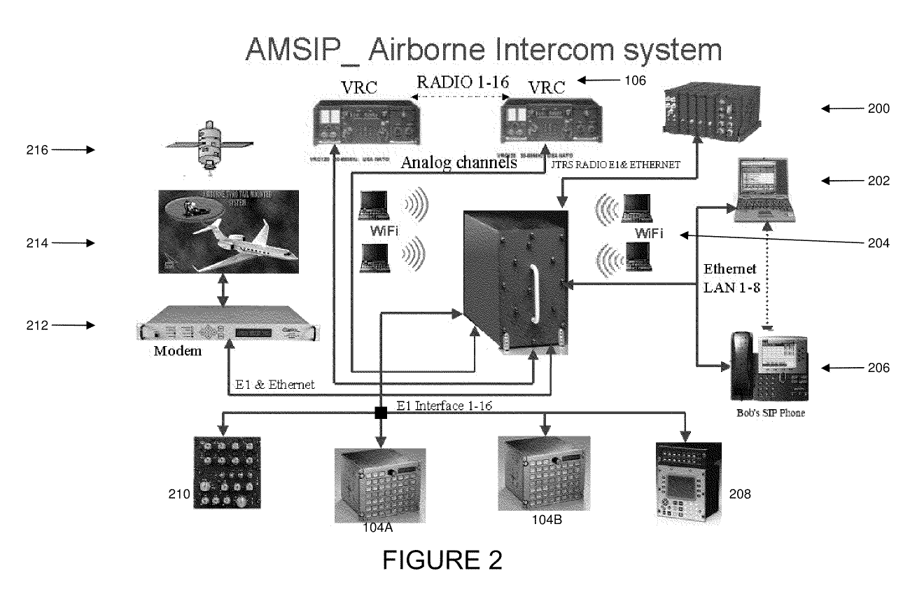

FIG. 2 is a high-level diagram of connections between the AMSIP and external communications systems. As noted above, connections are shown for an implementation of an airborne system. External communications systems include both ground-based and space-based connections. Connections are exemplary, and more or less connections can be used depending on the specific application. Connections may include, but are not limited to radios (with E1 or Ethernet interfaces) 200, computers with IP (internet protocol, via Ethernet or other types of networks) interfaces 202, WIFI 204, IP phones (enable system operators to communicate with other operators connected to IP phones) 206, optional control panels 208, 210, modems (used for converting signals received from satellites to audio signals provided to VAIU for monitoring by operators) 212, aircraft to satellite communication system 214, 216.

The AMSIP uses a centralized architecture with a digitally controlled central unit, VAIU 100 that manages the system functions, and performs the audio signals switching to establish the desired communication channels among audio stations and aircraft systems. Digital control and audio buses are used to transfer the control selection commands and digital audio signals from the audio stations to the central unit. This architecture allows the connection of different equipment types together without the need for other units for conversion between different types of communication buses, and facilitates an optimized solution for delay, flexibility, and multimedia communications.

The AMSIP supports the operation of a configurable number of Audio Control Panels (ACPs) (104A, 104B). The AMSIP provides all ACP stations with complete access to all system resources.

Function selection in the ACP, is converted to command, transmitted to the VAIU, in which the command is converted to internal selection command in the VAIU, for selecting the desired function or setting the desired volume level

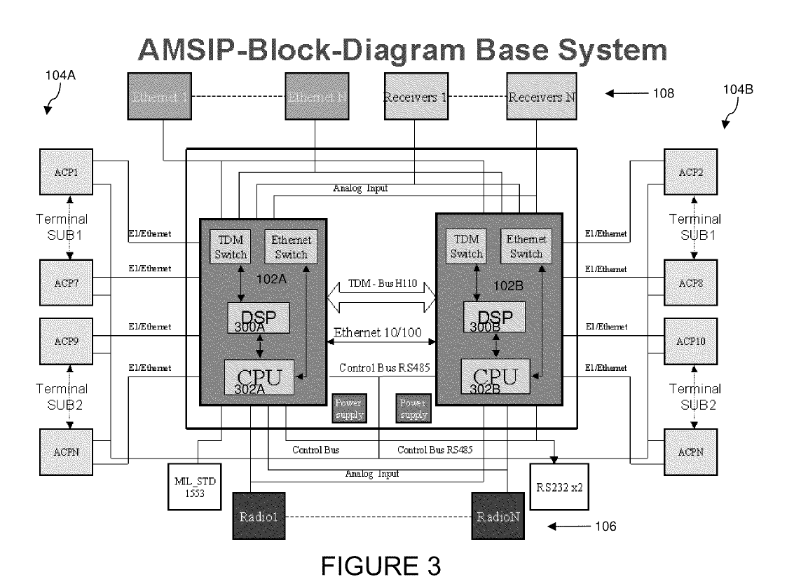

Referring also to FIG. 3, a detailed interconnection diagram of the architecture of a system for combining multiple media types for airborne and ship borne communications, known as Audio Management System over IP (AMSIP), an exemplary implementation of construction and operation of the system can be seen. The following description uses exemplary specifications for an airborne implementation for clarity. Depending on the application, additional and alternative implementations can be used, and the following description does not limit the scope of the system. AMSIP provides an interface with aircraft radio systems 106, receivers 108, ACPs (104A, 104B). Each sub-VAIU (102A, 102B) includes redundant components, including but not limited to DSPs (300A, 300B) and CPUs (302A, 302B). A variety of redundant communications connect the sub-VAIUs to AMSIP system components via Ethernet networks (123A, 123B), E1 (122A, 122B), TDM, RS-485 (124, 126), RS-232 128, radios 106, and analog inputs. Other system components include, but are not limited to, audio reception from the aircraft navigation and warning systems, outputs for the CVR Recorder, communication among mission crew stations using point to point, and conference nets communications, intercom communication with the flight deck and with the ground crew technician, communication with the reserve crews through 2-wire line, interface with IP radios, IP recorder and IP phone using standard real time protocol (RTP), relay functions between radios, using emergency and backup redundant operation modes, and connection to other aviation systems in the aircraft through Ethernet, TDM, and analog connections.

### DETAILED DESCRIPTION

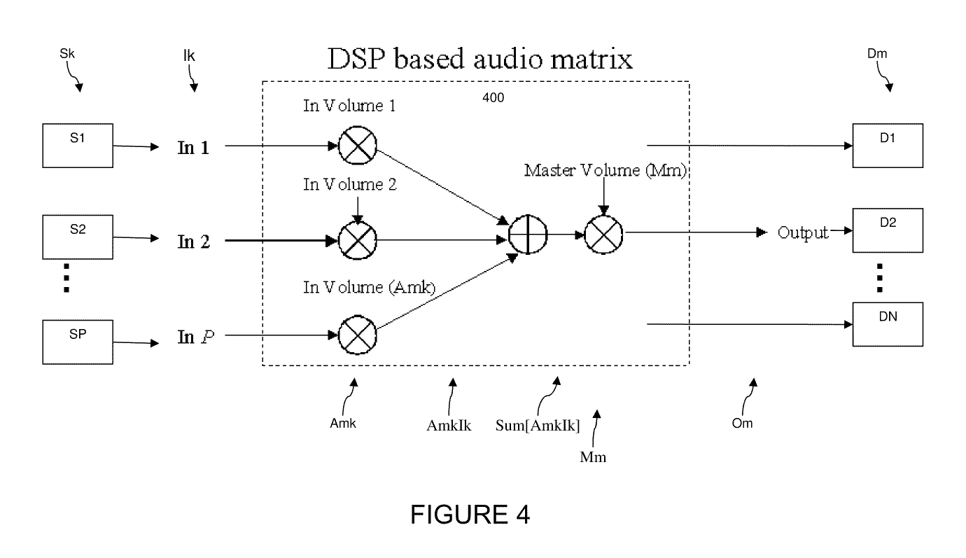

### DSP Switching—FIG. 4

Audio channels can be communicated in a variety of audio formats, depending on the specific audio communications system including, but not limited to analog, time division multiplexed (TDM), and VOIP. In this description, TDM refers to two audio formats. A first TDM audio format is the industry standard 8 bit, 8 KHz sampled, pulse code modulated (PCM), 64 Kilo bits per second (Kbps) digital signal that occupies one timeslot in an industry standard E1 signal, commonly known as a 4 KHz voice grade channel (VGC). A second TDM audio format is the innovative use of a higher quality 16 bit, 16 KHz sampled, sigma delta modulation (SDM), 256 Kbps digital signal that occupies four timeslots in an industry standard E1 signal. Analog inputs are sampled using this higher quality TDM signal, retaining a higher quality audio, which can be critical to audibility in airborne applications.

To facilitate integration of audio communications into a common system, a digital signal processing (DSP)-based switching system is used to convert audio channels between a variety of audio formats and switch audio channels between communication systems as necessary. Referring again to FIG. 3, audio channels are received by a sub-VAIU (102A, 102B). Each sub-VAN can accept a variety of audio formats including, but not limited to, analog, time division multiplexed (TDM), and VOIP. Each sub-VAN contains one or more components for optional conversion of audio formats and a DSP (300A, 300B) to switch the audio channels. As described above, analog inputs are sampled at 256 Kbps to provide a corresponding digitized audio source to the DSP (also referred to as a digital audio source). Digital audio sources can be converted from native formats, for example 64 Kbps TDM, to a common format of 256 Kbps for switching. Analog to digital conversion (ADC) and digital signal conversion, can be done by additional components (not shown in FIG. 3), such as CODECs or DSPs, to provide digital audio sources to the switching DSP (300A, 300B).

Referring to FIG. 4, a diagram of a DSP-based audio switching system, a plurality of digital audio sources (Sk) each provides an audio channel with associated source amplitude (Ik). The audio format of each channel is converted to a common audio format, in this case the above-described 256 Kbps TDM format, for input and processing by a DSP 400. The DSP 400 is operationally connected to each of the plurality of digital audio sources (Sk) and operationally connected to each of a plurality of audio destinations (Dm). The DSP 400 is configured to associate the plurality of audio destinations (Dm) with the plurality of digital audio sources (Sk), effectively implementing a switching matrix between DSP inputs and outputs. Associating audio destinations with digital audio sources includes a null association, in other words associating an audio destination with none of the audio inputs. An audio input can be associated with zero, one, or multiple audio destinations. Similarly, an audio destination can be associated with zero, one, or multiple audio inputs. In a case where multiple audio inputs are associated with the same audio destination, the audio inputs are combined into a single audio signal for the audio destination. The amplitude of individual audio inputs can be adjusted for each audio destination. In other words, in a case where an audio input is associated with more than one audio destination, the audio input is copied so that the audio input can be adjusted for each audio destination.

The DSP generates an amplified input (AmkIk) for each of the plurality of digital audio sources (Sk) that is associated with one or more of the plurality of audio destinations (Dm) by multiplying each of the associated source amplitudes (Ik) by an input gain (Amk).

The input gain (Amk) is based on one of the plurality of digital audio sources (Sk) and an associated one of the plurality of audio destinations (Dm). Note that the terminology used here is the common terminology used in the art, where referring to operations, such as multiplying, a source refers to operating on the data provided by the source. In a case where a digital audio source (Sk) lacks an associated audio destination (Dm), the input gain (Amk) is set to zero for that digital audio source (Sk).

The DSP generates a combined amplified input (Sum[AmkIk]) for each of the plurality of audio destinations (Dm) by combining the amplified input (AmkIk) for each of the plurality of digital audio sources (Sk) that is respectively associated with each of the plurality of audio destinations (Dm). The combined amplified inputs (Sum[AmkIk]) are output as destination amplitudes (Om) to correspondingly each of the plurality of audio destinations (Dm). Note that in FIG. 4, data flow for a single audio destination (D2) is shown for clarity, but the system can be configured for multiple data flows (Dm).

The DSP can be further configured to generate destination amplitudes (Om) by multiplying each of the combined amplified inputs (Sum[AmkIk]) by an output gain (Mm). The output gain (Mm) is based on an associated one of the audio destinations (Dm), effectively allowing a master volume control for each audio destination. The above-described preferred audio format of 256 Kbps TDM can be converted to a variety of formats depending on the audio destination. In a non-limiting example, if an audio destination is a conventional 64 Kbps TDM communications system, the 256 Kbps TDM signal is converted from 16 bit, 16 KHz sampled, PCM to 8 bit, 8 KHz sampled PCM.

The DSP 400 can be configured to process a variety of audio formats. Conventional audio processing uses the above-described 4 KHz VGC. A preferred implementation is to provide an audio channel (audio source) with an effective analog bandwidth equivalent of 6 KHz. In a case where an audio source provides an analog audio format, a preferred analog to digital sampling uses a sampling rate of 16 KHz and 16 bits of data to provide the above-described high quality TDM signal (256 Kbps). The AMSIP system facilitates processing of a wide range of media types, including voice signals from 8 Kbps to 256 Kbps.

The gain factors (Amk and Mm) can be pre-defined, or updated continuously, for example by commands from a CPU (FIG. 3, 302A, 302B) or by commands from a host processor on the AMSIP network, which is a result of command received from ACP (generated result of operator volume level setting). When the system and/or DSP is reset, preferably all gain factors are initialized to zero, then update gain factors based on system configuration or user input, for example via commands from a host processor on the AMSIP network. A host processor can also be used to send association information to the DSP, facilitating the DSP associating audio inputs with audio destinations.

A mathematical technique is now described for additional clarity of a DSP-based audio switching system. Note that inadvertent typographical errors or mathematical mistakes should not detract from the usefulness and demonstrated advantages of the current embodiment. A DSP generates up to N outputs for P inputs. The following signal names are defined:

Input channel k=1 . . . P (Ik)

Output of channel m=1 . . . N (Om)

Gain for input Ik for output Om (Amk)

Master volume for channel Om, (m=1 . . . N) (Mm)

Output level for channel m (Om) is defined by the relation:

$${O}_{m} = {M}_{m} * ( {\sum }_{k = 1}^{P} {A}_{mk} * / k )$$

### DETAILED DESCRIPTION

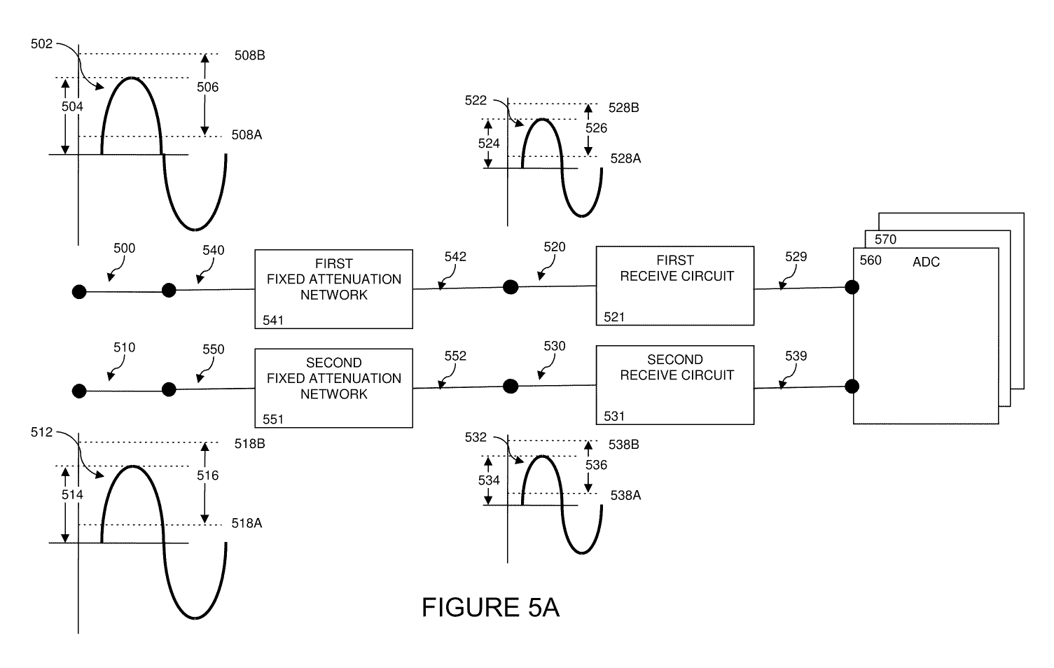

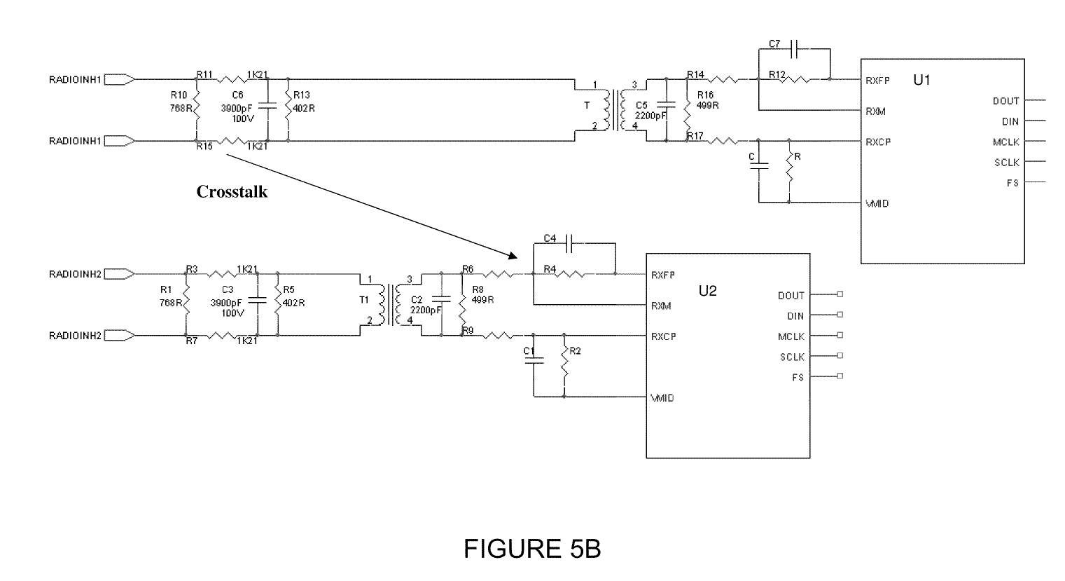

### Crosstalk Prevention—FIGS. 5A, 5B

A printed circuit (PC) board may contain many signal input terminals, for example channels of radio receivers. Such channel density can cause crosstalk, due to the proximity and density of channel conductors on the board. In airborne applications, a typical wide receiver input voltage range of 200 mV-12V can cause leakage (crosstalk), specifically from high to low-level inputs. This crosstalk reduces signal quality in a situation where high signal quality can be critical to airborne communications. Conventional techniques focus on crosstalk reduction, with much effort spent on complicated circuits to track signal inputs, and/or detect and eliminate crosstalk after a circuit has been affected by crosstalk.

An innovative technique is now presented that uses an architecture including fixed attenuation of signals at entry to prevent crosstalk. Specifically, given a known signal input range and a known receive signal input range, a fixed attenuation can be calculated and used near where a signal is input, preventing high current at the input circuit, reducing capacitance and inductance effects signal transmitted by the printed circuit board conductors, resulting in prevention of crosstalk between channels. A feature of this technique is that a wide dynamic range of input signals can be received.

Referring to FIG. 5A, a diagram of a system for crosstalk prevention, a first signal input terminal (500) is configured to receive a first analog input signal (502) of a first amplitude (504). A first signal input range (506) of the first amplitude (504) is between a pre-determined first minimum amplitude (508A) and a pre-determined first maximum amplitude (508B). Similarly, a second signal input terminal (510) is configured to receive a second analog input signal (512) of a second amplitude (514). A second signal input range (516) of the second amplitude (514) is between a pre-determined second minimum amplitude (518A) and a pre-determined second maximum amplitude (518B).

In the context of this description, a receive circuit is typically a long conductor, greater than about 3 inches for 10 KHz analog audio channels, connecting an input terminal at an edge of a PCB to components internal to a system that process the corresponding input signal (such as components on a PCB, for example an analog to digital converter, ADC). In this context, given an analog audio signal bandwidth of about 10 KHz a receive circuit that is longer than 3 inches can produce an undesirable level of crosstalk, greater than a pre-determined crosstalk maximum. In general, a distance from the first signal input terminal (500) to a first fixed attenuation network (541) is less than a calculated distance. The calculated distance is based on a bandwidth of the first analog input signal (502), such that a calculated crosstalk signal generated by the first analog input signal (502) is less than a pre-determined maximum value for allowable crosstalk in the system (referred to as the pre-determined crosstalk maximum).

A first receive circuit (521) has a first receive analog input terminal (520) configured to receive a first receive analog input signal (522) of a first receive amplitude (524). A first receive signal input range (526) of the first receive amplitude (524) is between a pre-determined first receive minimum amplitude (528A) and a pre-determined first receive maximum amplitude (528B). Similarly, a second receive circuit (531) has a second receive analog input terminal (530) configured to receive a second receive analog input signal (532) of a second receive amplitude (534). A second receive signal input range (536) of the second receive amplitude (534) is between a pre-determined second receive minimum amplitude (538A) and a pre-determined second receive maximum amplitude (538B).

A first fixed attenuation network (541) having a first attenuation input terminal (540) is operationally connected to the first signal input terminal (500) and a first attenuation output terminal (542) is operationally connected to the first receive analog input terminal (520). The first fixed attenuation network (541) is configured to apply a first attenuation to the first analog input signal (502) to provide the first receive analog input signal (522) via the first attenuation output terminal (542) to the first receive analog input terminal (520). The first attenuation is based on the first signal input range (506) and the first receive signal input range (526), such that a first crosstalk signal generated by the first receive circuit (521) and received by the second receive circuit (531) is less than a pre-determined crosstalk maximum.

As described above for 10 KHz bandwidths, the distance from a signal input terminal (such as first signal input terminal 500) to a fixed attenuation network (such as first fixed attenuation network 541) should be less than 3 inches to avoid significant crosstalk from signal entry to a PCB.

The signal input terminals (in this case 500 and 510) can be configured to receive balanced or singled-ended input signals. In a typical configuration, the signal input terminals (in this case 500 and 510) are adjacent to each other on a printed circuit (PC) board. In a typical airborne application, the pre-determined first minimum amplitude (508A) is 200 mV and the pre-determined first maximum amplitude (508B) is 12 V. In this case, the first attenuation is a factor of 14.

Similar to the above description, a second fixed attenuation network can be used with a second analog input signal (512) to prevent crosstalk to the first receive circuit (521). A second fixed attenuation network (551) has a second attenuation input terminal (550) operationally connected to the second signal input terminal (510) and a second attenuation output terminal (552) operationally connected to the second receive analog input terminal (530). The second fixed attenuation network (551) is configured to apply a second attenuation to the second analog input signal (512) to provide the second received analog input signal (532). The second attenuation is based on the second signal input range (516) and the second receive signal input range (536), such that a second crosstalk signal generated by the second received circuit (531) and received by the first receive circuit (521) is less than the pre-determined crosstalk maximum.

The above-described crosstalk prevention technique facilitates different input signals using different fixed attenuations. This can be useful in cases where a specific device and/or signal input range will be connected to a specific input terminal. In a case where any of a group of devices may be connected to any of multiple input terminals, the first signal input range (506) is substantially equal to the second signal input range (516), the first receive signal input range (526) is substantially equal to the second receive signal input range (536), and hence the first attenuation is substantially equal to the second attenuation.

A configuration of this crosstalk prevention network includes connection to an analog to digital converter (ADC). The first receive circuit (521) includes a first receive output terminal (529) operationally connected to a first ADC (560). The first receive analog input signal (522) is provided via the first receive output terminal (529) to the ADC. Depending on the specific application, ADC, and signal levels, the ADC component can include programmable amplification for the receive analog input signals. If the amplitude of a receive analog input signal is below the level required for converting in the ADC, the ADC component can include an amplification circuit prior to the conversion circuitry to amplify the receive analog input signal to a level acceptable for analog to digital conversion.

For clarity, the above-described crosstalk prevention system has been diagrammed and described with a limited number of signals. Based on this description, one knowledgeable in the art will be able to extend this system to additional numbers of input signals. In one preferred implementation, the second receive circuit (531) can include a second receive output terminal (539) operationally connected to first ADC (560), the second receive analog input signal (532) provided via the second receive output terminal (539) to first ADC (560). In another implementation, the system includes more than one ADC, and one or more analog input signals are provided to each ADC. A non-limiting example includes a second analog to digital converter (ADC) (570) wherein the second receive circuit (531) includes a second receive output terminal (539) operationally connected to the second ADC (570). The second receive analog input signal (532) is provided via the second receive output terminal (539) to the second ADC (570).

FIG. 5B is a detailed diagram of one exemplary implementation of a crosstalk prevention system. This implementation demonstrates a feature of this technique, in that the architecture supports receiving a wide dynamic range of input signals, in this case a range of 36 dB.

### DETAILED DESCRIPTION

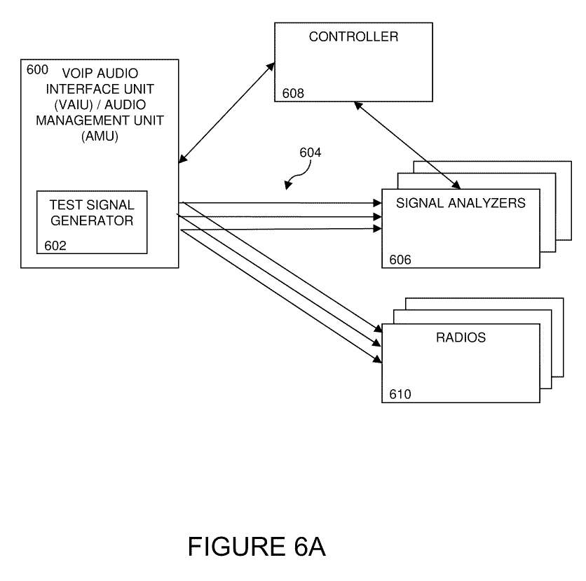

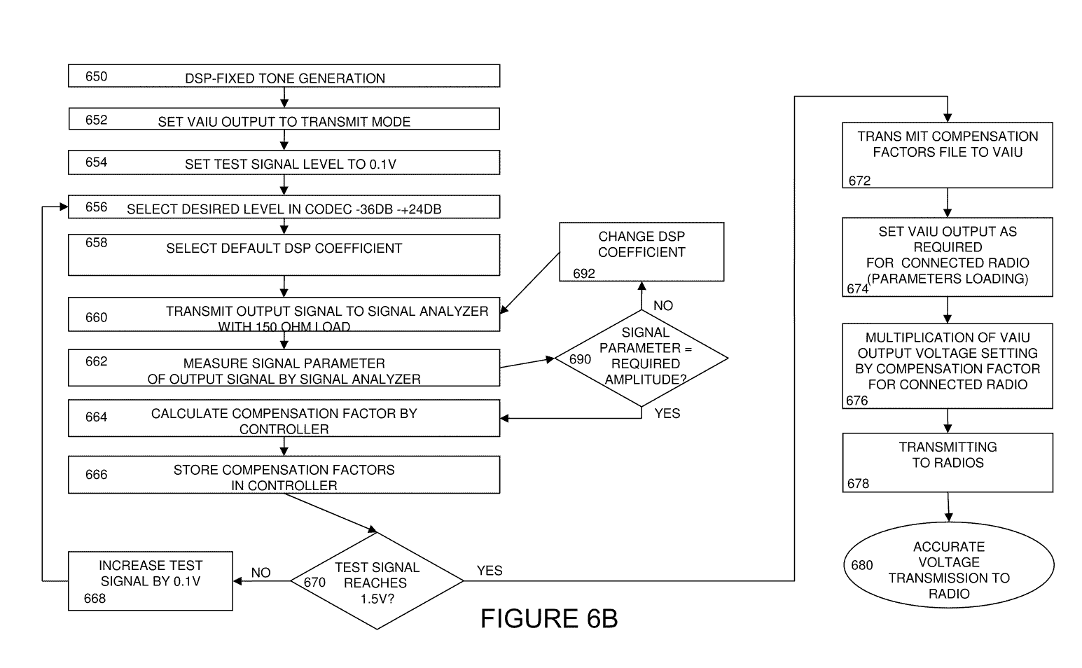

### Radio Channel Calibration—FIGS. 6A, 6B

When flying, an aircraft typically communicates with one or more external communications systems, such as a ground-based communication facility. Communicating from the aircraft to a ground-based communication facility over as great a distance as possible is desirable, as greater distances increase the usefulness and potential operations for which the aircraft can be used. An important factor in increasing external communications distances is the internal communications between a VOIP audio interface unit (AMU generally, or specifically a VAIU) and aircraft radios. Conventional systems typically work with an uncertainty as high as plus or minus 20% in the analog voltage output by a VAIU for input to an aircraft radio. This uncertainty results in a corresponding decrease in the external communications distance.

An innovative system for radio channel calibration is now described. This system has been shown to increase the accuracy of voltage transmission from a VAIU to a radio to less than plus or minus 10%, with a corresponding increase in the external communications distance.

Referring to FIG. 6A, a general diagram of a system for radio channel calibration, a test signal generator (602) is configured for generating one or more test signals of pre-determined amplitude. A VOIP audio interface unit (VAIU) (600) is operationally connected to the test signal generator (602). The VAIU is configured to transmit one or more output signals, each of the one or more output signals deriving from the one or more test signals. One or more signal analyzers (606) are operationally connected to the VAIU (600). The one or more signal analyzers are configured to receive the one or more output signals (604) and generate one or more signal parameters corresponding to each of the one or more output signals. A controller (608) is operationally connected to the VAIU (600) and operationally connected to one or more signal analyzers (606). The controller (608) is configured to process one or more signal parameters with corresponding one or more test signals to generate corresponding one or more compensation factors. The controller (608) is further configured to facilitate storage of one or more compensation factors in association with one or more test signals corresponding to the compensation factor. Based on this description, one skilled in the art will be able to implement alternative configurations, depending on the application. One non-limiting example of an alternative configuration is to use a switch (not shown in FIG. 6A) between the VAIU (600) and a single signal analyzer (connected as per 606) with controller (608) controlling the switch such that one output at a time of the VAIU is sent to the single signal analyzer.

A typical signal parameter is the voltage of an output signal from a VAIU that is received by a signal analyzer. The controller compares this voltage signal parameter to the voltage of the test signal generated by the required test signal level. The controller then generates a compensation factor of the deviation of the output voltage from the test voltage. Compensation factors can be generated for each output of the VAIU from a pre-determined minimum voltage to a pre-determined maximum voltage. Compensation factors are preferably stored in the VAIU.

In an optional implementation, this method of radio channel calibration can be repeated to provide more accurate compensation factors. The test signal generator is configured for generating one or more test signals with amplitudes based on comparing one or more signal parameters to a pre-determined required amplitude. In a non-limiting example, the test generator generates an initial test signal at a default voltage level, which results in a corresponding output signal from the VAIU and corresponding signal parameter, in this case voltage, from the signal analyzer. The voltage measured at the signal analyzer is compared to a pre-determined required voltage. If the voltage measured is greater than the pre-determined required voltage, the test generator generates a subsequent test signal with a lower voltage level. Similarly, if the voltage measured is less than the pre-determined required voltage, the test generator generates a subsequent test signal with a higher voltage level. This comparison and generation cycle is repeated with subsequently smaller voltage step increases or decreases until the voltage measured is within a pre-determined error range of the pre-determined required amplitude.

Generation of compensation factors can be done before operations, for example during acceptance testing or configuration of a VAIU. In a preferred implementation, radios (610) are not needed during calibration. Instead, the connections for the one or more output signals (604) are loaded with the known input resistance of the radios to be used. A typical loading for aircraft radios is 150 Ohms. During flight operations when the VAIU wants to transmit a specific voltage out, for example to drive a specific radio that has been connected to the VAIU, the VAIU can use the compensation factors to transmit the desired specific voltage.

The test signal generator (602) can be included in the VAIU (600) or be a stand-alone equipment operationally connected to the VAIU. A preferable configuration is a DSP-based test signal generator internal to the VAIU. The test signal can generate audio test signals for an aircraft communications system. One or more test signals can be generated with pre-determined amplitudes between 0.1 volts (V) and 1.5 V in steps of 0.1 V. The controller (608) can be included in the VAIU (600) or be stand-alone equipment operationally connected to the VAIU. One or more radios (610) can be operationally connected to the VAIU, each of the one or more radios having a pre-determined radio input amplitude. In this case, the VAIU is configured to use one or more compensation factors to transmit one or more communication signals at the pre-determined radio input amplitude to a respective one or more radios.

Referring to FIG. 6B, a flowchart of an exemplary method for radio channel calibration, a DSP-based fixed tone is generated 650 as a test signal. Note that multiple radios can be calibrated in parallel, and this example describes calibration of a single radio for clarity. 16 radios are to be calibrated in this example, and the output of the VAIU (AMU) for a first radio is selected and the VAIU output is set to transmit mode 652. Calibration will be for voltage levels from 0.1 V to 1.5 V and the voltage level for the first test signal is set to the minimum voltage of 0.1V 654. The desired level is selected in CODEC from −36 dB to +24 dB 656. Initially, a default DSP coefficient is selected for the required calibration 658. The default compensation factor is a fixed factor used in the software to enable setting the required output voltage, within the required range and is used before calibration. A test signal is then transmitted 660 from the VAIU as an output signal. As described above, the output signal can be loaded with the known input resistance of the radio, typically 150 Ohms for aircraft radios.

The output signal is measured 662 by a signal analyzer that determines one or more signal parameters of interest. A typical signal parameter is the voltage level of the output signal.

A controller uses signal parameter information from the signal analyzer with information from the originally generated test signal to calculate 664 a compensation factor. The compensation factor is typically stored 666 on the controller during radio channel calibration. In block 670, if the desired range of voltage levels has not yet been tested, in this example 0.1 V to 1.5 V, the method continues in block 668 by increasing the voltage level for the test signal by a pre-defined step size, in this example 0.1 V, and repeating testing at block 656.

In an optional implementation, this method of radio channel calibration can be repeated to provide more accurate compensation factors. After measuring one or more signal parameters of interest in block 662, the method continues in block 690 by comparing one or more signal parameters to pre-determined required signal parameters. A typical comparison is the voltage level measured of the output signal to a required voltage level (amplitude). If the voltage level of the output signal is not within a pre-determined error range of the pre-determined required amplitude, the method continues in block 692 with changing the DSP coefficient. If the voltage measured is greater than the pre-determined required voltage, the DSP coefficient is changed so the test generator generates a subsequent test signal with a lower voltage level. Similarly, if the voltage measured is less than the pre-determined required voltage, the DSP coefficient is changed so the test generator generates a subsequent test signal with a higher voltage level. This comparison and generation cycle is repeated with subsequently smaller voltage step increases or decreases. When the comparison in block 690 results in the voltage being within a pre-determined error range of the pre-determined required amplitude, the method continues in block 664 calculating the compensation factor.

When the desired range of voltage levels has been tested, the method continues with block 672 where the compensation factors are transferred to the VAIU. For operations, radios are connected to the VAIU and the operating parameters for each radio are set 674 in the VAIU. In this example, a primary parameter is the optimal voltage level for input to each radio connected to the VAIU. The VAIU uses the stored compensation factors to adjust the transmission signal 676, for example by multiplication of the transmission signal by the appropriate compensation factor. The adjusted output signal from the VAIU is transmitted to the radios 678, providing 680 an accurate voltage to a corresponding radio.

### DETAILED DESCRIPTION

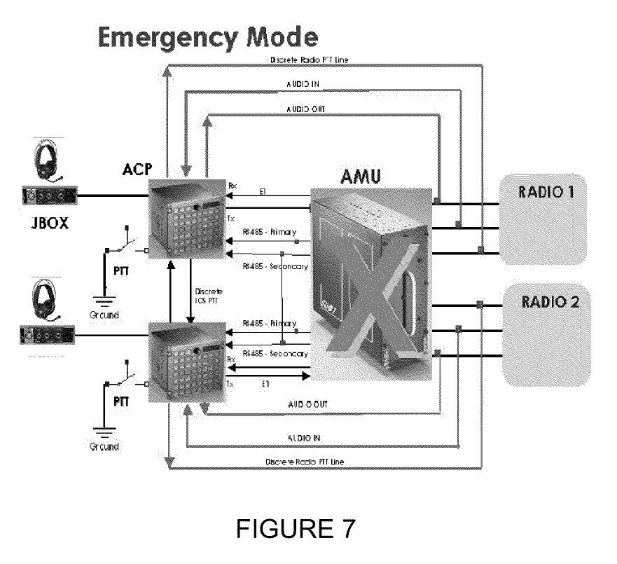

### FIGS. 7-11

Referring to FIG. 7, a diagram of emergency mode operation, the AMSIP system is optimized to the high safety requirements of an airborne environment and includes features that support continuing operations during loss of one or more system components. The VAIU is configured with two separate and independent SUB-VAIU modules to provide system redundancy. Each SUB-VAIU includes a CPU, power supply, and audio interface circuits. If the VAIU malfunctions, an emergency mode facilitates system components bypassing the VAIU and directly connecting an ACP to predefined radio and intercom networks.

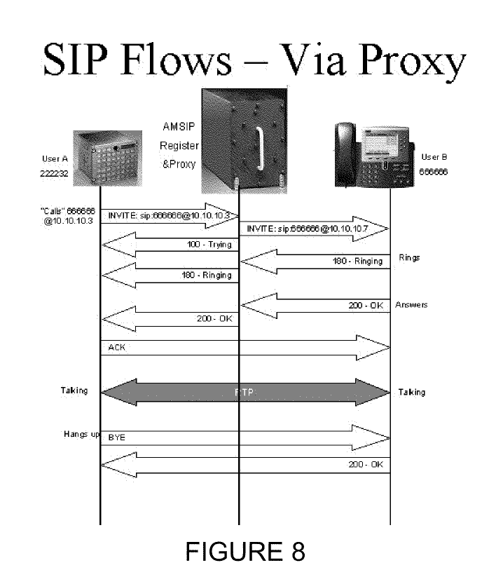

FIG. 8 is an example of a SIP call setup procedure, in particular, a description of the establishment of a conversation between ACP and the end unit IP Phone.

On power up, the AMSIP registers the component telephone systems connected to the AMSIP. Upon a dial to an IP phone number, the AMSIP connects to that telephone system.

The AMSIP system supports IP voice communications, including VOIP using the SIP protocol. Standard VOIP SIP connections are supported. In general, the AMSIP system enables, typically via Ethernet links, different types of net conferences and routing between different operators, of audio or video data with participants both on the ground and in the air (inside and outside cockpit) and enables during conferences to add additional participants to the conference in real time. One technology for implementing such communication is SIP. Although direct dial to external phones is available today via conventional systems, the AMSIP system facilitates other communications such as video, audio, and digital data to be compressed, and using the VOIP interfaces only when required, allowing higher quality audio links for flight crew and audio systems in an aircraft.

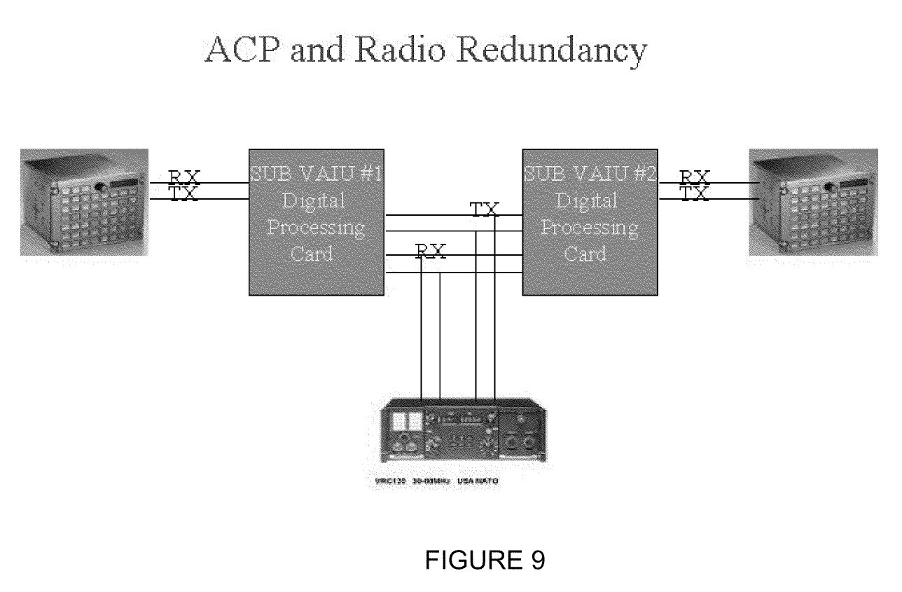

FIG. 9 is a diagram of ACP and radio redundancy. As described above, the AMSIP system is built as two identical parts, each part has redundant components, including a power supply, CPU, and interface to external lines. A failure in one part does not affect the second part.

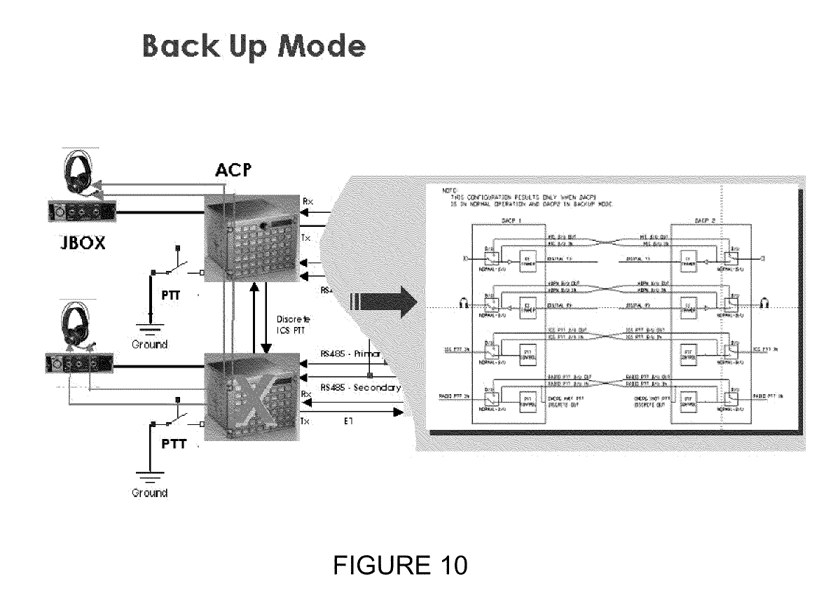

FIG. 10 is a diagram of backup mode. In backup mode an operator can bypass the operator's failed ACP (such as during an operational failure or power drop), and connect an operator headset in parallel to a predefined backup partner ACP. This architecture also provides a redundant control bus, for operation in emergency and backup modes. Multiple radios, receive inputs, and input discrete lines are connected internally to both SUB-VAN modules, to provide redundancy.

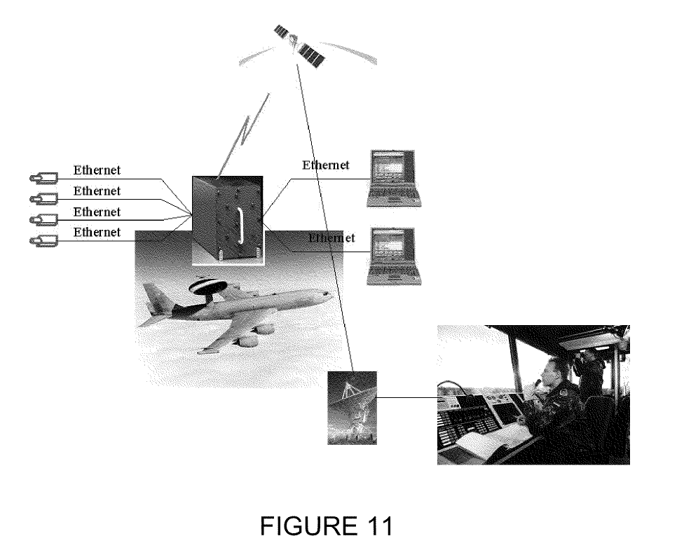

FIG. 11 is a diagram of an example of some of the internal aircraft and external communications connections.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

An AMSIP system integrating multiple media types into a common system reduces the total weight of the system, reduces cabling and routing costs, and simplifies operations as compared to conventional systems. Operation can be through an integrated aircraft panel allowing aircraft pilot, copilot, mission operators, and other crewmembers access to multiple media communications, facilitating simplification of user interfaces and reducing the use of precious aircraft space. Enabling use of the optimal communication system for each media type allows an AMSIP user to use a higher quality audio channel, such as TDM, when available, and maintain audio connections via a compressed VOIP channels when bandwidth is limited. High quality audio, such as 256 Kbps TDM signals, can be used on-board and compressed, such as using G.711 or G.729 to reduce the bit rate to 6.4 Kbps, for transmitting audio via external communications.

It will be appreciated that the above descriptions are intended only to serve as examples, and that many other embodiments are possible within the scope of the present invention as defined in the appended claims.

What is claimed is:

1. A system for switching signals comprising:
(a) a plurality of digital audio sources (Sₖ) each providing an audio channel with associated source amplitude (Iₖ);
(b) a plurality of audio destinations (Dₘ);
(c) a digital signal processor (DSP) operationally connected to each of said plurality of digital audio sources (Sₖ) and operationally connected to each of said plurality of audio destinations (Dₘ), said DSP configured to:
(i) associate said plurality of audio destinations (Dₘ) with said plurality of digital audio sources (Sₖ);
(ii) generate an amplified input (AₘₖIₖ) for each of said plurality of digital audio sources (Sₖ) that has an association with one or more of said plurality of audio destinations (Dₘ) by multiplying each of the associated source amplitudes (Iₖ) by an input gain (Aₘₖ), said input gain (Aₘₖ) based on one of said plurality of digital audio sources (Sₖ) and an associated one of said plurality of audio destinations (Dₘ); and
(iii) generate combined amplified inputs (Sum[AₘₖIₖ]) for each of said plurality of audio destinations (Dₘ) by combining said amplified input (AₘₖIₖ) for each of said plurality of digital audio sources (Sₖ) that is respectively associated with each of said plurality of audio destinations (Dₘ); and
(d) output said combined amplified inputs (Sum[AₘₖIₖ]) as destination amplitudes (Oₘ) to correspondingly each of said plurality of audio destinations (Dₘ).

2. The system of claim 1 wherein said DSP is further configured to generate destination amplitudes (Oₘ) by multiplying each of said combined amplified inputs (Sum[AₘₖIₖ]) by an output gain (Mₘ), said output gain (Mₘ) based on an associated one of said audio destinations (Dₘ);

3. The system of claim 1 wherein said input gain (Aₘₖ) is set to zero for each of said plurality of digital audio sources (Sₖ) that lacks an associated one of said plurality of audio destinations (Dₘ).

4. The system of claim 1 wherein said DSP is configured to accept at least one of said plurality of digital audio sources (Sₖ) having an effective analog bandwidth equivalent of 6 KHz.

5. The system of claim 1 wherein said DSP is configured to accept at least one of said plurality of digital audio sources (Sₖ) having a sampling rate of 16 KHz and 16 bits of data.

6. The system of claim 1 wherein said plurality of digital audio sources includes airborne audio control panels (ACPs).

7. The system of claim 1 wherein said plurality of digital audio sources include audio from aircraft navigation and warning systems.

8. The system of claim 1 wherein said plurality of audio destinations include airborne audio control panels (ACPs).

9. The system of claim 1 wherein said plurality of audio destinations include aircraft black box flight data recorder (FDR).

10. The system of claim 1 wherein said plurality of audio destinations includes aircraft radios.

11. A system for crosstalk reduction comprising:
(a) a first signal input terminal (500) configured to receive a first analog input signal (502) of a first amplitude (504), wherein a first signal input range (506) of said first amplitude (504) is between a pre-determined first minimum amplitude (508A) and a pre-determined first maximum amplitude (508B);
(b) a second signal input terminal (510) configured to receive a second analog input signal (512) of a second amplitude (514), wherein a second signal input range (516) of said second amplitude (514) is between a pre-determined second minimum amplitude (518A) and a pre-determined second maximum amplitude (518B);
(c) a first receive circuit (521) having a first receive analog input terminal (520) configured to receive a first receive analog input signal (522) of a first receive amplitude (524), wherein a first receive signal input range (526) of said first receive amplitude (524) is between a pre-determined first receive minimum amplitude (528A) and a pre-determined first receive maximum amplitude (528B);
(d) a second receive circuit (531) having a second receive analog input terminal (530) configured to receive a second receive analog input signal (532) of a second receive amplitude (534), wherein a second receive signal input range (536) of said second receive amplitude (534) is between a pre-determined second receive minimum amplitude (538A) and a pre-determined second receive maximum amplitude (538B); and
(e) a first fixed attenuation network (541) having a first attenuation input terminal (540) operationally connected to said first signal input terminal (500) and a first attenuation output terminal (542) operationally connected to said first receive analog input terminal (520), wherein said first fixed attenuation network (541) is configured to apply a first attenuation to said first analog input signal (502) to provide said first receive analog input signal (522) via said first attenuation output terminal (542) to said first receive analog input terminal (520), wherein said first attenuation is based on said first signal input range (506) and said first receive signal input range (526), such that a first crosstalk signal generated by said first receive circuit (521) and received by said second receive circuit (531) is less than a pre-determined crosstalk maximum.

12. The system of claim 11 wherein said first signal input terminal (500) is configured to receive a first analog input signal (502) that is balanced.

13. The system of claim 11 wherein said first signal input terminal (500) is configured to receive a first analog input signal (502) that is singled-ended.

14. The system of claim 11 wherein said first signal input terminal (500) and said second signal input terminal (510) are adjacent to each other on a printed circuit (PC) board.

15. The system of claim 11 wherein said pre-determined first minimum amplitude (508A) is 200 mV and said pre-determined first maximum amplitude (508B) is 12 V.

16. The system of claim 15 wherein said first attenuation is 23 dB.

17. The system of claim 11 wherein a distance from said first signal input terminal (500) to said first fixed attenuation network (541) is less than a calculated distance, said calculated distance based on a bandwidth of said first analog input signal (502), such that a calculated crosstalk signal generated by said first analog input signal (502) is less than said pre-determined crosstalk maximum.

18. The system of claim 11 wherein a bandwidth of said first analog input signal (502) is 10 KHz or less and a distance from said first signal input terminal (500) to said first fixed attenuation network (541) is 3 inches or less.

19. The system of claim 11 further including a second fixed attenuation network (551) having a second attenuation input terminal (550) operationally connected to said second signal input terminal (510) and a second attenuation output terminal (552) operationally connected to said second receive analog input terminal (530), wherein said second fixed attenuation network (551) is configured to apply a second attenuation to said second analog input signal (512) to provide said second receive analog input signal (532), wherein said second attenuation is based on said second signal input range (516) and said second receive signal input range (536), such that a second crosstalk signal generated by said second receive circuit (531) and received by said first receive circuit (521) is less than said pre-determined crosstalk maximum.

20. The system of claim 19 wherein said first signal input range (506) is substantially equal to said second signal input range (516), said first receive signal input range (526) is substantially equal to said second receive signal input range (536), and hence said first attenuation is substantially equal to said second attenuation.

21. The system of claim 11 further including a first analog to digital converter (ADC) (560), wherein said first receive circuit (521) includes a first receive output terminal (529) operationally connected to said first ADC (560), said first receive analog input signal (522) provided via said first receive output terminal (529) to said first ADC (560).

22. The system of claim 21 wherein said second receive circuit (531) includes a second receive output terminal (539) operationally connected to said first ADC (560), said second receive analog input signal (532) provided via said second receive output terminal (539) to said first ADC (560).

23. The system of claim 21 further including a second analog to digital converter (ADC) (570) wherein said second receive circuit (531) includes a second receive output terminal (539) operationally connected to said second ADC (570), said second receive analog input signal (532) provided via said second receive output terminal (539) to said second ADC (570).

24. A system for calibration comprising:
(a) a test signal generator (602) configured for generating one or more test signals;
(b) an VOIP audio interface unit (VAIU) (600) operationally connected to said test signal generator (602), said VAIU configured to transmit one or more output signals, each of said one or more output signals (604) deriving from a corresponding one of said one or more test signals;
(c) one or more signal analyzers (606) operationally connected to said VAIU (600), said one or more signal analyzers (606) configured to receive said one or more output signals (604) and generate one or more signal parameters corresponding to each of said one or more output signals (604); and
(d) a controller (608) operationally connected to said VAIU (600) and operationally connected to said one or more signal analyzers (606), said controller configured to:
(i) process said one or more signal parameters with corresponding one of said one or more test signals to generate corresponding one or more compensation factors; and
(ii) facilitate storage of said one or more compensation factors in association with said corresponding one of said one or more test signals.

25. The system of claim 24 wherein said test signal generator is included in said VAIU.

26. The system of claim 24 wherein said test signal generator is a digital signal processor (DSP)-based fixed tone generator.

27. The system of claim 24 wherein said test signal generator is configured to generate audio test signals.

28. The system of claim 24 wherein said VAIU is included in an aircraft communications system.

29. The system of claim 24 wherein said test signal generator is configured for generating said one or more test signals with respective amplitudes between 0.1 volts (V) and 1.5 V in steps of 0.1 V.

30. The system of claim 24 wherein said test signal generator is configured for generating said one or more test signals with amplitudes based on comparing said one or more signal parameters to a pre-determined required amplitude.

31. The system of claim 30 wherein said test signal generator is configured to repeat generating said one or more test signals with amplitudes based on comparing said one or more signal parameters to a pre-determined required amplitude until said one or more signal parameters are within a pre-determined error range of said pre-determined required amplitude.

32. The system of claim 24 wherein said controller is included in said VAIU.

33. The system of claim 24 wherein said one or more compensation factors are stored in said VAIU.

34. The system of claim 24 including one or more aircraft radios (610) operationally connected to said VAIU, each of said one or more aircraft radios having a pre-determined radio input amplitude, and wherein said VAIU is configured to use said one or more compensation factors to transmit one or more communication signals at said pre-determined radio input amplitude to a respective one or more radios.

35. A method for switching signals comprising the steps of:
(a) associating a plurality of audio destinations (Dₘ) with a plurality of digital audio sources (Sₖ), wherein each of said plurality of digital audio sources (Sk) provides an audio channel with associated source amplitude (Ik);
(b) generating an amplified input (AₘₖIₖ) for each of said plurality of digital audio sources (Sₖ) that has an association with one or more of said plurality of audio destinations (Dₘ) by multiplying each of the associated source amplitudes (Iₖ) by an input gain (Aₘₖ), said input gain (Aₘₖ) based on one of said plurality of digital audio sources (Sₖ) and an associated one of said plurality of audio destinations (Dₘ);
(c) generating combined amplified inputs (Sum[AₘₖIₖ]) for each of said plurality of audio destinations (Dₘ) by combining said amplified input (AₘₖIₖ) for each of said plurality of digital audio sources (Sₖ) that is respectively associated with each of said plurality of audio destinations (Dₘ); and
(d) outputting said combined amplified inputs (Sum[AₘₖIₖ]) as destination amplitudes (Oₘ) to correspondingly each of said plurality of audio destinations (Dₘ).

36. The method of claim 35 wherein outputting said combined amplified inputs (Sum[AmkIk]) as destination amplitudes (Oₘ) includes multiplying each of said combined amplified inputs (Sum[AₘₖIₖ]) by an output gain (Mₘ), said output gain (Mₘ) based on an associated one of said audio destinations (Dₘ);

37. The method of claim 35 wherein said input gain (Aₘₖ) is set to zero for each of said plurality of digital audio sources (Sₖ) that lacks an associated one of said plurality of audio destinations (Dₘ).

38. The method of claim 35 wherein at least one of said plurality of digital audio sources (Sₖ) has an effective analog bandwidth equivalent of 6 KHz.

39. The method of claim 35 wherein at least one of said plurality of digital audio sources (Sₖ) has a sampling rate of 16 KHz and 16 bits of data.

40. The method of claim 35 wherein said plurality of digital audio sources includes airborne audio control panels (ACPs).

41. A method for crosstalk reduction comprising the steps of:
(a) receiving a first analog input signal (502) having a first signal input range (506), at a first signal input terminal (500);
(b) receiving a second analog input signal (512) having a second signal input range (516), at a second signal input terminal (510); and
(c) applying a first attenuation to said first analog input signal (502) wherein said first attenuation is based on said first signal input range (506) such that a first crosstalk signal generated by a first receive circuit (521) operationally connected to said first signal input terminal (500) and received by a second receive circuit (531) operationally connected to said second signal input terminal (510), is less than a pre-determined crosstalk maximum.

42. The method of claim 41 wherein said first signal input range (506) is between a pre-determined first minimum amplitude (508A) of 200 mV and a pre-determined first maximum amplitude (508B) of 12 V.

43. The method of claim 41 wherein said first attenuation is 23 dB.

44. The method of claim 41 wherein a distance from said first signal input terminal (500) to a first fixed attenuation network (541) is less than a calculated distance, said calculated distance based on a bandwidth of said first analog input signal (502), such that a calculated crosstalk signal generated by said first analog input signal (502) is less than said pre-determined crosstalk maximum.

45. The method of claim 41 wherein a bandwidth of said first analog input signal (502) is 10 KHz or less and a distance from said first signal input terminal (500) to a first fixed attenuation network (541) is 3 inches or less.

46. The method of claim 41 further including the step of applying a second attenuation to said second analog input signal (512) wherein said second attenuation is based on said second signal input range (516) such that a second crosstalk signal generated by a second receive circuit (531) operationally connected to said second signal input terminal (510) and received by a first receive circuit (521) operationally connected to said first signal input terminal (500), is less than a pre-determined crosstalk maximum.

47. The method of claim 46 wherein said first signal input range (506) is substantially equal to said second signal input range (516), said first receive signal input range (526) is substantially equal to said second receive signal input range (536), and hence said first attenuation is substantially equal to said second attenuation.

48. A method for calibration comprising the steps of:
(a) generating one or more test signals;
(b) transmitting one or more output signals, each of said one or more output signals (604) deriving from a corresponding one of said one or more test signals;
(c) measuring said one or more output signals (604) and generating one or more signal parameters corresponding to each of said one or more output signals (604); and
(d) processing said one or more signal parameters with corresponding one of said one or more test signals to generate corresponding one or more compensation factors; and
(e) storing said one or more compensation factors in association with said corresponding one of said one or more test signals.

49. The method of claim 48 wherein said one or more test signals are generated by an aircraft VOIP audio interface unit (VAIU).

50. The method of claim 48 wherein generating one or more test signals is based on comparing said one or more signal parameters to a pre-determined required amplitude.

51. The method of claim 50 wherein generating one or more test signals based on comparing said one or more signal parameters to a pre-determined required amplitude is repeated until said one or more signal parameters are within a pre-determined error range of said pre-determined required amplitude.

52. The method of claim 48 wherein said one or more compensation factors are used to transmit one or more communication signals at a pre-determined radio input amplitude to a respective one or more aircraft radios.
